(19) United States
(12) Patent Application Publication
(10) Pub. No.: US 2022/0367973 A1
(43) Pub. Date: Nov. 17, 2022

(54) COPOLYESTER FILMS FOR USE AS SEPARATORS IN LITHIUM-ION WET CELL BATTERIES

(71) Applicant: DuPont Teijin Films U.S. Limited Partnership, Wilmington, DE (US)

(72) Inventors: Stephen Sankey, Wilton, Middlesbrough (GB); Stephen Jones, Wilton, Middlesbrough (GB); Lucien Schosseler, Luxembourg (LU); Megan Todd, Wilton, Middlesbrough (GB); David Turner, Wilton, Middlesbrough (GB)

(73) Assignee: DuPont Teijin Films U.S. Limited Partnership, Wilmington, DE (US)

(21) Appl. No.: 17/763,387

(22) PCT Filed: Sep. 29, 2020
(86) PCT No.: PCT/GB2020/052350

§ 371 Date: Mar. 24, 2022

(30) Foreign Application Priority Data
Sep. 30, 2019 (GB) 1914085.4

(51) Int. Cl. H01M 50/414; H01M 50/406

(52) U.S. Cl. CPC H01M 50/414; H01M 50/406

(57) ABSTRACT

Use of a copolyester film in the manufacture of a lithium-ion wet cell battery comprising an anode, a cathode and an electrolyte, wherein the copolyester film comprises a copolyester which comprises repeating units derived from a diol, a dicarboxylic acid and a poly(alkylene oxide)glycol.

The present invention is concerned with copolyester films which exhibit advantageous properties for use as battery separators, articles made therefrom and methods for their manufacture.

Lithium-ion batteries are widely used in the field of rechargeable batteries which is set to continually grow over the foreseeable future due, in part, to the increasing demand for consumer electronics and storage of renewable energy. During battery operation (i.e. during charging and discharging), lithium ions are transferred between the anode and cathode. Commercially available lithium-ion batteries are usually provided as wet-cell batteries which contain liquid or gel electrolytes containing lithium salts and a microporous separator. The microporous separator is placed between and in contact with two active solid electrodes. Generally, microporous separators for lithium-ion batteries have a thickness of about 20 μm to about 25 μm and are based on drawn polyolefin films (particularly polyethylene and polypropylene). The separator enables the movement of the liquid or gel electrolyte through its pores, thereby enabling movement of the lithium ions, but prevents direct electric contact between the anode and cathode in the battery. A disadvantage of polyolefin films as separators is their relatively low mechanical strength, particularly the relatively low tensile strength in the transverse direction of a biaxially drawn film.

Furthermore, during battery operation, the volume of the anode and cathode changes. Thus, the separator needs to accommodate these variations in volume. If the separator is too rigid, it may be damaged during the charging and discharging cycles or have limited cycling capability.

It is an object of the present invention to address one or more of the aforementioned problems. In particular, it is an object of the present invention to provide improved films for use as separators in a lithium-ion battery that comprises liquid electrolytes. It is a particular object to provide films which at least maintain and preferably improve the conductivities of existing separators, and/or which exhibit good mechanical strength and dimensional stability at low thicknesses. It is a particular object of the present invention to provide films which at least maintain and preferably improve the conductivities of existing lithium-conductive separators and/or which exhibit good mechanical strength and dimensional stability at low thicknesses, while also ensuring ease of film formation and battery manufacture.

According to the first aspect of the present invention, there is provided the use of a copolyester film in the manufacture of a lithium-ion wet cell battery comprising an anode, a cathode and an electrolyte, wherein the copolyester film comprises a copolyester which comprises repeating units derived from a diol, a dicarboxylic acid and a poly(alkylene oxide)glycol, wherein said copolyester film does not comprise lithium ions, and wherein during said manufacture said copolyester film is disposed in said battery as a separator between the anode and the cathode.

During said manufacture of said battery, said copolyester film which does not comprise lithium ions may be contacted with said electrolyte before, or after, said copolyester film is disposed in said battery as a separator between the anode and the cathode. Preferably, however, during said manufacture of said battery, said copolyester film which does not comprise lithium ions is contacted with said electrolyte prior to said copolyester film being disposed in said battery as a separator between the anode and the cathode.

The copolyester films described herein are suitable for use as a separator in a wet cell battery. The inventors have surprisingly found that the films described herein exhibit good conductivity across a range of commercially useful temperatures. The films described herein exhibit an excellent combination of good conductivity and high mechanical strength at low thicknesses, while remaining easy to form. The separators derived from the copolyester films described herein exhibit excellent dimensional stability, particularly at elevated temperatures, and are able to tolerate the volume variations of electrodes during typical battery cycling.

As used herein, the term “copolyester” refers to a polymer which comprises ester linkages and which is derived from three or more types of comonomers. The copolyesters described herein are thermoplastic.

Suitable dicarboxylic acids for the copolyester include aromatic dicarboxylic acids such as terephthalic acid, isophthalic acid, phthalic acid and naphthalene dicarboxylic acid (such as 2,5-, 2,6- or 2,7-naphthalene dicarboxylic acid), as well as aliphatic dicarboxylic acids such as succinic acid, sebacic acid, adipic acid and azelaic acid. Cycloaliphatic dicarboxylic acids may also be used. Other suitable dicarboxylic acids include 4,4′-diphenyldicarboxylic acid and hexahydro-terephthalic acid. Preferably, the dicarboxylic acid used in the present invention is an aromatic dicarboxylic acid, most preferably terephthalic acid.

The copolyester preferably comprises at least one aromatic dicarboxylic acid, preferably terephthalic or naphthalene dicarboxylic acids, and preferably terephthalic acid. In a first and most preferred embodiment, the dicarboxylic acid component comprises only one aromatic dicarboxylic acid. In a second embodiment, the dicarboxylic acid component comprises a first aromatic dicarboxylic acid (preferably terephthalic acid) and a second dicarboxylic acid. The second dicarboxylic acid may be selected from aliphatic dicarboxylic acids such as succinic acid, sebacic acid, adipic acid or azelaic acid, and in one embodiment the second dicarboxylic acid is azelaic acid.

Suitable diols for the copolyester include acyclic, alicyclic and aromatic dihydroxy compounds. Preferred diols have 2-15 carbon atoms, and include ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, and 1,5-dihydroxynaphthalene, etc. An aliphatic diol is preferred, especially acyclic aliphatic diols containing 2-8 carbon atoms, especially aliphatic diols containing 2-4 carbon atoms. An unbranched aliphatic diol is preferred. Preferably the diol is selected from ethylene glycol, 1,3-propanediol and 1,4-butanediol, more preferably from ethylene glycol and 1,4-butanediol, and most preferably ethylene glycol. Cycloaliphatic (alicylic) glycols such as 1,4-cyclohexanedimethanol (CHDM) can also be used. Equivalent ester-forming derivatives of diols may be used in place of said diol. Preferably, the copolyester comprises only one type of diol residue. In one embodiment, at least 90 mol %, preferably at least 95 mol %, preferably at least 98 mol %, and preferably at least 99 mol % of said diol fraction is made up of one type of diol.

Suitable poly(alkylene oxide) glycols for the copolyester are preferably selected from poly(alkylene oxide) glycols having C₂ to C₁₅, more preferably C₂ to C₁₀, and more preferably C₂ to C₆ alkylene chains. The poly(alkylene oxide) glycol is preferably selected from polyethylene glycol (PEG), polypropylene glycol (PPG) and poly(tetramethylene oxide) glycol (PTMO), and most preferably is polyethylene glycol. Ethylene oxide-terminated poly(propylene oxide) segments may also be used. Mixtures of poly(alkylene oxide) glycols can be used, but in a preferred embodiment the copolyester comprises only one type of poly(alkylene oxide) glycol residue.

The poly(alkylene oxide) glycol preferably constitutes from about 0.1 to about 70 wt %, preferably from about 0.5 to about 65 wt %, preferably from about 1 to about 60 wt %, preferably from about 2 to about 50 wt %, preferably from about 5 to about 50 wt %, preferably from about 7 to about 40 wt %, preferably from about 8 to about 30 wt %, preferably from about 10 to about 25 wt %, preferably from about 10 to about 12 wt % by total weight of said copolyester.

Preferably, the poly(alkylene oxide) glycol constitutes at least 1%, preferably at least 2%, preferably at least 5%, preferably at least 10%, preferably no more than 70%, preferably no more than 50%, preferably no more than 40%, preferably no more than 30%, preferably no more than 25% by total weight of said copolyester.

Thus, in a preferred embodiment, the copolyester comprises and preferably consists of repeating units derived from an aliphatic diol (preferably ethylene glycol), an aromatic dicarboxylic acid (preferably terephthalic acid) and a poly(alkylene oxide) glycol (preferably PEG).

It will be appreciated that the diol, dicarboxylic acid and poly(alkylene oxide)glycol repeating units of the copolyester, as described hereinabove, together preferably constitute at least 96 wt %, preferably at least 97 wt %, preferably at least 98 wt % by total weight of said copolyester, and preferably constitute substantially of the copolyester.

The weight average molecular weight (M_{W}) of the poly(alkylene oxide) glycol is preferably from about 200 g/mol to 20000 g/mol, preferably from about 200 g/mol to 6000 g/mol, preferably from about 200 g/mol to 5000 g/mol, preferably no more than about 5000 g/mol, preferably no more than about 4000 g/mol, preferably from about 400 g/mol to 3900 g/mol, preferably at least about 500 g/mol, preferably from about 500 g/mol to 3800 g/mol, most preferably from about 500 g/mol to 3700 g/mol, preferably from about 800 g/mol to about 3600 g/mol, preferably from about 1000 g/mol to about 3600 g/mol, preferably from about 2000 g/mol to about 3500 g/mol, and preferably about 3450 g/mol. The weight average molecular weight (M_{w}) of the poly(alkylene oxide) is preferably at least about 200 g/mol, preferably at least about 400 g/mol, preferably at least about 500 g/mol, and preferably at least about 800 g/mol, for example at least about 1000 g/mol. The weight average molecular weight (M_{w}) of the poly(alkylene oxide) is preferably no more than about 20000 g/mol, preferably no more than about 5000 g/mol, preferably no more than about 4000 g/mol, and preferably no more than about 3800 g/mol, for example no more than about 3700 g/mol.

It has been found that if the molecular weight of the poly(alkylene oxide) is too high, it becomes harder to co-polymerise with the dicarboxylic acid and aliphatic diol to form a copolyester with a sufficiently high melt viscosity for reliable film formation. In addition, it has been found that if the molecular weight of the poly(alkylene oxide) is too high, the conductivity may decrease.

Unless the context clearly indicates otherwise the term molecular weight as used herein refers to weight average molecular weight (M_{w}) which is measured by the method as described herein.

The number average molecular weight (Mₙ) may also be used to characterise the poly(alkylene oxide)described herein. The number average molecular weight (Mₙ) of the poly(alkylene oxide) is preferably from about 150 g/mol to 15000 g/mol, preferably from about 150 g/mol to 4000 g/mol, preferably no more than about 3000 g/mol, preferably from about 300 g/mol to 3000 g/mol, preferably at least about 400 g/mol, preferably from about 400 g/mol to 2000 g/mol, most preferably from about 400 g/mol to 1300 g/mol, preferably from about 700 g/mol to about 1000 g/mol and preferably about 800 g/mol. The number average molecular weight (Mₙ) of the poly(alkylene oxide) is preferably at least about 150 g/mol, preferably at least about 300 g/mol, preferably at least about 400 g/mol, and preferably at least about 700 g/mol, for example about 800 g/mol. The number average molecular weight (Mₙ) of the poly(alkylene oxide) is preferably no more than about 18000 g/mol, preferably no more than about 4000 g/mol, preferably no more than about 3000 g/mol, and preferably no more than about 2000 g/mol, for example no more than about 1300 g/mol.

The polydispersity index, PDI, (or dispersity, D) is defined as Mw/Mn. The polydispersity index is a measure of the uniformity (or heterogeneity) of the size of the different macromolecules that comprise a polymer (which is a mixture of macromolecules of different sizes). Compositions with a polydispersity index of 1 (i.e. which are monodisperse) consist of macromolecules each of which has the same size. Monodisperse compositions of macromolecules are typically made by non-polymerisation processes and are typically not referred to as polymers.

The poly(alkylene oxide) of the copolyester preferably has a polydispersity index of above 1, preferably at least about 1.01, preferably at least about 1.1, preferably at least about 1.2, and preferably no more than about 2.0, preferably no more than about 1.8, preferably no more than about 1.6, and preferably from about 1.01 to about 2.0, preferably about 1.1 to about 1.8, and preferably about 1.2 to about 1.6.

The copolyesters may be block (segmented) copolymers comprising alternating random-length sequences joined by ester linkages. Such copolyesters exhibit semi-crystalline (or hard) segments derived from a dicarboxylic acid (preferably an aromatic acid) and a diol (preferably an aliphatic diol), and amorphous (or soft) segments derived from a poly(alkylene oxide) glycol. Hard segments may be made up of repeating units of [R₁—O—C(═O)-A-C(═O)—O] wherein R₁ is derived from the diol and A is the aromatic ring (preferably phenyl or naphthyl) derived from the aromatic dicarboxylic acid defined hereinabove. Soft segments may be made up of repeating units of [R—O] where R is the alkylene chain from the poly(alkylene oxide) glycol. The soft segments may be end-capped with said aromatic dicarboxylic acid via an ester linkage.

Preferably, the copolyester film is substantially free of plasticizer. Preferably, the total amount by weight of plasticizer (if present) is no more than 15%, preferably no more than 10%, preferably no more than 5%, preferably no more than 2% based of the weight of film being 100%. Preferably, the total amount by weight of plasticizer is about 0% (e.g. being absent) based of the weight of film being 100%. A plasticizer is a material which is added to a composition to reduce its viscosity, flexibility, workability and/or stretchability. Materials that might act to plasticize the copolyester films of the present invention are well known to those skilled in the art. Advantageously, the amount of plasticizer used in preparing the copolyester films described herein can be reduced or in a preferred embodiment eliminated completely.

The copolyesters described herein can be synthesised according to conventional techniques for the manufacture of polyester materials. Thus, the copolyester may be made by a first step of direct esterification or trans-esterification, followed by a second step of polycondensation. In the direct esterification embodiment, the diol and dicarboxylic acid are reacted directly, typically under elevated temperature (typically about 150 to 260° C.) and pressure (typically about 40 psi) in the presence of a base (e.g. sodium hydroxide), and with the water by-product of the direct esterification reaction being distilled off, to form a bis(hydroxyalkyl)carboxylate. Once the direct esterification reaction is complete, a stabiliser (e.g. phosphoric acid) is added to neutralise the base. In an alternative embodiment, the copolyester is prepared by the trans-esterification route, which preferably comprises heating an ester of the dicarboxylic acid (suitably a lower alkyl (C₁₋₄) ester, preferably the dimethyl ester) with a molar excess of the diol at elevated temperature (typically in the range of about 150 to 260° C.) in the presence of a basic esterification catalyst (e.g. manganese (II) acetate tetrahydrate, Mn(OAc)₂.4H₂O), and with the methanol by-product of the trans-esterification reaction being distilled off, to form a bis(hydroxyalkyl)carboxylate. Polymerisation is effected in a polycondensation step which is conducted using an appropriate catalyst, usually antimony trioxide, at elevated temperature (typically about 290° C.) and typically under reduced pressure (for instance about 1 mm Hg), with continuous distillation of by-product(s).

The poly(alkylene oxide) may be present at the start of the synthetic procedure, since the dicarboxylic acid or dicarboxylic acid ester starting material typically reacts selectively with the diol rather than the poly(alkylene oxide), particularly as the molecular weight of the poly(alkylene oxide) increases. Preferably, however, the poly(alkylene oxide) is added at the start of the polycondensation step.

Preferably, the synthetic procedure further comprises a solid phase polymerisation (SSP) step to increase the molecular weight of the copolyester and increase and/or complete the polymerisation of the poly(alkylene oxide) into the copolyester.

Thus, the product of the polycondensation reaction is preferably subjected to an SSP step. The solid phase polymerisation may be carried out in a fluidised bed, e.g. fluidised with nitrogen, or in a vacuum fluidised bed, using a rotary vacuum drier. Suitable solid phase polymerisation techniques are disclosed in, for example, EP-A-0419400 the disclosure of which is incorporated herein by reference. Thus, SSP is typically conducted at a temperature which is 10-50° C. below the crystalline melting point (T_{M}) of the polymer but higher than the glass transition temperature (T_{g}) (or where the copolyester exhibits multiple glass transition temperatures higher than the highest glass transition temperature). An inert atmosphere of dry nitrogen or a vacuum is used to prevent degradation. In a preferred embodiment, solid phase polymerisation is carried out over 16 hours at 220° C. under vacuum.

The inventors have found that as the SSP reaction time is increased, there is a decrease in the total amount of extractables in the copolyester and the relative amount of unreacted poly(alkylene oxide) in the extracted material.

The total extractables content of the copolyester film is preferably less than 5%, preferably less than 3%, preferably less than 2%, preferably less than 1% by total weight of the copolyester film prior to the extraction.

The extent to which the poly(alkylene oxide) starting material has copolymerised into the copolyester is defined herein as the parameter “PAG copolymerisation”, and can be calculated from the amount of poly(alkylene oxide) starting material and the amount of poly(alkylene oxide) in the total extractables content:

$$PAG copolymerisation ( \% ) = ( \frac{{ω}_{PAG - FEED} - {ω}_{PAG - EXTRACT}}{{ω}_{PAG - FEED}} ) \times 100$$

wherein ω_{PAG-FEED} and to ω_{PAG-EXTRACT} are the mass fractions of poly(alkylene oxide) starting material and the amount of poly(alkylene oxide) in the total extractables content, respectively. The amount of unreacted poly(alkylene oxide) in the total extractables content may be determined by conventional analytical techniques, and preferably by ¹H NMR spectroscopy.

Preferably, the PAG copolymerisation is at least 95%, preferably at least 96%, preferably at least 97%, preferably at least 98%, preferably at least 99%.

The melt viscosity of the copolyester from which the film is derived is preferably at least about 0.1 Pa·s, preferably not more than about 1000 Pa·s, preferably not more than about 800 Pa·s, preferably not more than about 500 Pa·s, preferably not more than about 300 Pa·s, and preferably at least about 100 Pa·s, preferably at least about 150 Pa·s, at the desired processing temperature. Thus, preferably the melt viscosity of the copolyester is from 0.1 to 1000 Pa·s, more preferably from 100 to 800 Pa·s, more preferably from 150 to 500 Pa·s, most preferably from 150 to 300 Pas at the desired processing temperature. Typical processing temperatures at which the copolyester should exhibit such melt viscosities are those used in the manufacture of the film described herein, and are preferably in the range of 200 to 300° C., particularly 220 to 280° C., and preferably at 275° C., and/or wherein the copolyester exhibits such melt viscosities at a temperature within the range of TM to TM+10° C. wherein TM is the crystalline melting temperature of the copolyester. A melt viscosity which is too high can lead to difficulties in film manufacture and/or reduce the molecular weight of the final copolyester and/or increase the cost of film manufacture, for instance because of the need to utilise specialised film-forming equipment. In addition, a melt viscosity which is too high may require a reduction in the output rate of the extruder, thereby decreasing the efficiency and economy of manufacture, or require an increase to the extrusion temperature in order to reduce the viscosity of the melt (which in turn can lead to thermal degradation of the polymer and the loss of associated properties), in order to achieve stable film production. A melt viscosity which is too low can lead to difficulties in reliable film formation and stretching.

The copolyester films described herein are preferably oriented copolyester films, preferably biaxially oriented copolyester films.

The optionally oriented films described herein are preferably self-supporting films, i.e. they are capable of independent existence in the absence of a supporting base.

Formation of the film may be effected by conventional extrusion techniques well-known in the art. In general terms the process comprises the steps of extruding a layer of molten copolyester at a temperature within a range appropriate to the melting temperature of the copolyester (typically no more than about 10° C. higher than the crystalline melting point of the copolyester), quenching the extrudate and orienting the quenched extrudate.

Orientation may be effected by any process known in the art for producing an oriented film, for example a tubular or flat film process. Biaxial orientation is effected by drawing in two mutually perpendicular directions in the plane of the film to achieve a satisfactory combination of mechanical and physical properties. Biaxial orientation may be effected by simultaneous orientation or by sequential orientation.

Simultaneous biaxial orientation may be effected, for instance, in a tubular process by extruding a thermoplastics polyester tube which is subsequently quenched, reheated and then expanded by internal gas pressure to induce transverse orientation, and withdrawn at a rate which will induce longitudinal orientation. Particularly suitable simultaneous biaxial orientation processes are disclosed in EP-2108673-A and US-2009/0117362-A1, the disclosure of which processes is incorporated herein by reference.

Another preferred technique is a flat film process in which the film-forming copolyester is extruded through a slot die and rapidly quenched upon a chilled casting drum to ensure that the copolyester is quenched to the amorphous state. Orientation is then effected by stretching the quenched extrudate in at least one direction at a temperature above the glass transition temperature(s) of the copolyester. Sequential orientation may be effected by stretching a flat, quenched extrudate firstly in one direction, usually the longitudinal direction, i.e. the forward direction through the film stretching machine, and then in the transverse direction. Forward stretching of the extrudate is conveniently effected over a set of rotating rolls or between two pairs of nip rolls, transverse stretching then being effected in a stenter apparatus.

Stretching is generally effected so that the dimension of the oriented film is from 2 to 7, preferably from 2 to 5, more preferably 2.5 to 4.5, more preferably 3.0 to 4.5, more preferably 3.5 to 4.5 times its original dimension in the or each direction of stretching. Stretching is conventionally effected at temperatures higher than the T_{g} of the copolyester composition, preferably at least about 5° C. higher, preferably at least about 15° C. higher than the T_{g}, and preferably in the range of from about T_{g}+5° C. to about T_{g}+75° C., preferably from about T_{g}+5° C. to about T_{g}+30° C. Thus, typically stretching is effected at temperatures in the range of about 5 to about 155° C., preferably about 5 to about 110° C. Greater draw ratios (for example, up to about 8 times) may be used if orientation in only one direction is required. It is not necessary to stretch equally in the machine and transverse directions although this is preferred if balanced properties are desired.

Stretching and orientation of the copolyester film improves the mechanical properties of the copolyester film and preferably can also improve the conductivity of the copolyester film.

Preferably, a simultaneous biaxial stretching process is used, which is particularly advantageous for making the thin films described herein.

A stretched film may be, and preferably is, dimensionally stabilised by heat-setting under dimensional support at a temperature above the glass transition temperature(s) of the copolyester but below the melting temperature (T_{M}) thereof, to induce the desired crystallinity of the copolyester. During the heat-setting, a small amount of dimensional relaxation may be performed in the transverse direction (TD) and/or machine direction (MD). The dimensional relaxation of up to 10%, more typically up to about 8%. Dimensional relaxation in the transverse direction is referred to in the art as “toe-in”, and typically involves a dimensional shrinkage of up to about 5%, typically from about 2 to about 4%. Dimensional relaxation in the machine direction may be effected by conventional techniques, although it is a relatively more difficult process to achieve since low line tensions are required particularly in a sequential orientation process. For this reason, a simultaneous orientation process is preferably used where MD relaxation is desired and, in this embodiment, simultaneous relaxation in the MD and TD is typically effected. The actual heat-set temperature and time will vary depending on the composition of the film and its desired final thermal shrinkage but should not be selected so as to substantially degrade the toughness properties of the film such as tear resistance. Within these constraints, preferred films are heat-set at a temperature from about 80° C. less than the melting temperature of the film (i.e. T_{M}−80° C.) to about 10° C. less than T_{M} (i.e. T_{M}−10° C.), preferably from about T_{M}−70° C. to about T_{M}−20° C. Thus, the heat-set temperature is suitably in the range of from about 130 to about 245° C., preferably from about 150 to about 245° C., and preferably at least 180° C., preferably in the range of 190 to 230° C. After heat-setting the film is typically quenched rapidly in order induce the desired crystallinity of the copolyester.

In one embodiment, particularly where the film has been oriented in a sequential orientation process, the film may be further stabilized through use of an in-line relaxation stage. Alternatively the relaxation treatment can be performed off-line. The relaxation of the film is between 0% and 10%, preferably 5%. In this additional step, the film is heated at a temperature lower than that of the heat-setting stage, and with a much reduced MD and TD tension. For a relaxation process which controls the film speed, the reduction in film speed (and therefore the strain relaxation) is typically in the range 0 to 2.5%, preferably 0.5 to 2.0%. There is no increase in the transverse dimension of the film during the heat-stabilisation step. The temperature to be used for the heat stabilisation step can vary depending on the desired combination of properties from the final film, with a higher temperature giving better, i.e. lower, residual shrinkage properties. A temperature of 135 to 250° C. is generally desirable, preferably 150 to 230° C., more preferably 170 to 200° C. The duration of heating will depend on the temperature used but is typically in the range of 10 to 40 seconds, with a duration of 20 to 30 seconds being preferred. This heat stabilisation process can be carried out by a variety of methods, including flat and vertical configurations and either “off-line” as a separate process step or “in-line” as a continuation of the film manufacturing process. Film thus processed will exhibit a smaller thermal shrinkage than that produced in the absence of such post heat-setting relaxation.

Advantageously, the film may be and preferably is manufactured in air, i.e. wherein the film is not manufactured (including the steps of extrusion, casting and stretching) under the atmosphere of an inert gas (such as nitrogen or a noble gas such as argon). Thus, the copolyester compositions and films described herein are surprisingly thermally stable, and do not require any special handling conditions, in particular an inert atmosphere, during manufacture or storage.

Thus, it will be appreciated that the copolyester film is suitably a mono-layer film.

The thickness of the film is preferably at least about 0.3 μm, preferably at least about 0.5 μm, preferably at least about 0.9 μm. Typically, the thickness of the film is at least about 1.0 μm, typically at least about 1.5 μm, typically at least about 2.0 μm.

The thickness of the film is preferably no more than 25 μm, preferably no more than about 20 μm, preferably no more than about 18 μm, preferably no more than about 15 μm, preferably no more than about 12 μm, preferably no more than about 9 μm, preferably no more than about 7 μm, preferably no more than about 5 μm.

The thickness of the film is therefore advantageously from about 0.3 μm to 25 μm, preferably from about 0.3 μm to about 20 μm, preferably from about 0.3 μm to about 18 μm, preferably from about 0.5 μm to about 15 μm, preferably from about 0.9 μm to about 12 μm, typically from about 1.0 μm to about 9 μm, typically from about 1.5 μm to about 7 μm, typically from about from about 2.0 μm to about 5 μm.

The copolyester is preferably the major component of the film, and makes up at least 50%, preferably at least 65%, preferably at least 75%, preferably at least 85%, and preferably at least 95%, preferably at least 98% by weight of the total weight of the film. Said copolyester is preferably the only polyester present in the film.

The film may further comprise any other additive conventionally employed in the manufacture of polyester films. Thus, agents such as anti-oxidants, UV-absorbers, hydrolysis stabilisers, cross-linking agents, dyes, fillers, pigments, voiding agents, lubricants, radical scavengers, thermal stabilisers, flame retardants and inhibitors, anti-blocking agents, surface active agents, slip aids, gloss improvers, prodegradents, viscosity modifiers and dispersion stabilisers may be incorporated as appropriate. Such additives may be introduced into the copolyester in a conventional manner. For example, the additive(s) may be introduced by mixing with the monomeric reactants from which the film-forming copolyester composition is derived, or the additive(s) may be mixed with the copolyester composition by tumble or dry blending or by compounding in an extruder, followed by cooling and, usually, comminution into granules or chips. Masterbatching technology may also be employed.

The film may, in particular, comprise a particulate filler which can improve handling and windability during manufacture and any downstream processing. The particulate filler may, for example, be a particulate inorganic filler (e.g. metal or metalloid oxides, such as alumina, titania, talc and silica (especially precipitated or diatomaceous silica and silica gels), calcined china clay and alkaline metal salts, such as the carbonates and sulphates of calcium and barium). To provide acceptable handling and windability, fillers are typically used in only small amounts, generally such that the total weight of filler is not more than about 6.0%, preferably not more than about 4.0%, preferably not more than about 2.5%, preferably not more than about 2.0%, preferably not more than about 1.0%, more typically no more than about 0.6% and preferably no more than about 0.3% by weight, based on the weight of the copolyester in the film. The inorganic filler should have a particle size which is smaller than the film thickness, and preferably the particle size is preferably no more than 10 μm, preferably no more than about 5 μm, preferably no more than about 2 μm, preferably in the range of from about 0.5 μm to about 2.0 μm.

As used herein, the term “particle size” refers to the volume distributed median particle diameter (equivalent spherical diameter corresponding to 50% of the volume of all the particles, read on the cumulative distribution curve relating volume % to the diameter of the particles—often referred to as the “D(v,0.5)” value) thereof. Particle size of the particles may be measured by electron microscope, coulter counter, sedimentation analysis and static or dynamic light scattering. Techniques based on laser light diffraction (Fraunhofer diffraction) are preferred. A particularly preferred method utilises a Mastersizer (e.g. a 3000) available from Malvern. The median particle size may be determined by plotting a cumulative distribution curve representing the percentage of particle volume below chosen particle sizes and measuring the 50th percentile. The modality of the particulate filler size distributions is not limited, and may be mono-modal, bi-modal or tri-modal.

In a preferred embodiment, the film comprises an anti-oxidant. A range of antioxidants may be used, such as antioxidants which function by trapping radicals or by decomposing peroxide. Suitable radical-trapping antioxidants include hindered phenols, secondary aromatic amines and hindered amines, such as Tinuvin™ 770 (Ciba-Geigy). Suitable peroxide-decomposing antioxidants include trivalent phosphorous compounds, such as phosphonites, phosphites (e.g. triphenyl phosphate and trialkylphosphites) and thiosynergists (e.g. esters of thiodipropionic acid, such as dilauryl thiodipropionate). Hindered phenol antioxidants are preferred. A particularly preferred hindered phenol is tetrakis-(methylene 3-(4′-hydroxy-3′,5′-di-t-butylphenyl propionate) methane, which is commercially available as Irganox™ 1010 (Ciba-Geigy). Other suitable commercially available hindered phenols include Irganox™ 1035, 1076, 1098 and 1330 (Ciba-Geigy), Santanox™ R (Monsanto), Cyanox™ antioxidants (American Cyanamid) and Goodrite™ antioxidants (BF Goodrich). The concentration of antioxidant present in the film is preferably in the range from 50 ppm to 5000 ppm, more preferably in the range from 300 ppm to 1500 ppm, particularly in the range from 400 ppm to 1200 ppm, and especially in the range from 450 ppm to 600 ppm based on the weight of the copolyester. A mixture of more than one antioxidant may be used, in which case the total concentration thereof is preferably within the aforementioned ranges. Incorporation of the antioxidant into the copolyester may be effected by conventional techniques, and preferably by mixing with the monomeric reactants from which the copolyester is derived, particularly at the end of the direct esterification or ester exchange reaction, prior to polycondensation.

The film should have low shrinkage, preferably less than 10.0%, preferably less than 5.0%, preferably less than 4.0%, preferably less than 3.0%, preferably less than 2.0%, preferably less than 1.0%, after 30 mins at 100° C. Preferably such low shrinkage values are exhibited in both dimensions of the film (i.e. the machine and transverse dimensions).

Preferably the crystalline melting point (T_{g}) of the film is greater than 175° C., preferably greater than 200° C., preferably greater than 210° C., preferably greater than 220° C. In comparison, polyolefin films generally used as microporous separators for lithium-ion batteries typically have a crystalline melting point (T_{g}) of about 130° C. to 150° C. This relative increase in T_{g} is advantageous as the films described herein could therefore be used in applications which require higher operating temperatures. Preferably the crystalline melting point (T_{g}) of the film is not more than 270° C.

Preferably, the film of the present invention exhibits a glass transition temperature (T_{g}) of no more than about 60° C., preferably no more than about 55° C., preferably no more than about 50° C. In the present invention, a lower T_{g} is preferred since it promotes greater conductivity at the operating temperature of the film in the preferred end-use described herein. The films of the present invention typically exhibit a T_{g} of at least about −50° C., for example at least about 0° C.

According to a second aspect of the present invention, there is provided a method of manufacturing a lithium-ion wet cell battery comprising an anode, a cathode, a separator between the anode and the cathode, and an electrolyte, the method comprising the steps of:
(a) preparing or obtaining a separator which is or comprises (and preferably consists of) a copolyester film which does not comprise lithium ions as described herein;
(b) preparing or obtaining an electrolyte;
(c) assembling the battery, wherein the battery comprises an anode, a cathode, a separator between the anode and the cathode, and an electrolyte, wherein said separator is obtained from step (a) and wherein said electrolyte is obtained from step (b).

In the method of the second aspect, said copolyester film which does not comprise lithium ions may be contacted with said electrolyte before, or after, said copolyester film is disposed in said battery as a separator between the anode and the cathode. Preferably, however, in the method of the second aspect, said copolyester film which does not comprise lithium ions is contacted with said electrolyte prior to said copolyester film being disposed in said battery as a separator between the anode and the cathode. Said copolyester film which does not comprise lithium ions may be contacted with said electrolyte by any suitable means, and is preferably so contacted by soaking said copolyester film in a container of said electrolyte.

It will be appreciated that the monolayer copolyester film described herein is disposed in said battery in direct contact with the anode and the cathode, i.e. without intervening layers between the anode and the copolyester film or between the cathode and the copolyester film.

It will be appreciated that said electrolyte of said wet cell battery is a liquid or gel electrolyte.

Preferably the electrolyte comprises one or more lithium salts. When determining suitable lithium salts, the solubility, conductivity, electrochemical and thermal stability, and cost should be considered. Any suitable lithium salt may be used.

Suitable lithium salts include lithium hexafluorophosphate (LiPF₆), lithium hexafluoroarsenate (LiAsF₆), lithium tetrafluoroborate (LIBF₄), lithium bis(trifluoromethanesulfonyl)imide (LiTFSI), lithium thiocyanate (LiSCN), lithium trifluoromethanesulfonate (LiCF₃SO₃), lithium bromide (LiBr), lithium iodide (Lip, lithium bis(trifluoromethanesulfonimide) (LiN(CF₃SO₂)₂), lithium tris(trifluoromethylsulfonyl)methide (LiC(CF₃SO₂)₃), lithium orthosilicate (Li₄O₄Si), lithium trifluoroacetate (LiCF₃CO₂), lithium bis(fluorosulfite)amide (LiN(FO₂S)₂)LiClO₄, lithium iron phosphate (LiFePO₄), lithium bis(oxalate)borate (LiBOB) and lithium difluorophosphate (LiPO₂F₂). Preferably, the lithium salt is LiPF₆.

In a preferred embodiment, the lithium salts are selected from lithium salts of:
(i) aromatic carboxylic acids, preferably aromatic dicarboxylic acids, preferably terephthalic acid;
(ii) aliphatic carboxylic acids, including aliphatic dicarboxylic acids, preferably acetic acid, glycolic acid or succinic acid;
(iii) carbonic acids;
(iv) phenolic acids, preferably salicylic acid;
(v) mineral acids, such as perchloric acid or phosphoric acid, particularly phosphoric acid; and
(vi) boric acids, preferably bis(oxalate)boric acid.

Thus, suitable lithium salts include: dilithium terephthalate (DLTA), lithium glycolate, lithium benzoate, lithium acetate, lithium carbonate, lithium perchlorate, lithium orthosilicate, lithium phosphate, lithium salicylate, lithium succinate and lithium bis(oxalato)borate.

Preferably, the lithium salt is an organic lithium salt.

In a preferred embodiment, the lithium salt is the salt of the aromatic dicarboxylic acid from which the copolyester is derived. Thus, in the case of the preferred copolyesters derived from terephthalic acid, the lithium salt is preferably selected from mono- or di-lithium terephthalate, and preferably dilithium terephthalate. The inventors have found that dilithium terephthalate is particularly preferable for thermal stability and cost reasons.

Other preferred lithium salts may be selected from the alkoxylate esters of the aforementioned acids, particularly the carboxylic acids, particularly the dicarboxylic acids, particularly the aromatic dicarboxylic acids, particularly terephthalic acid. Such alkoxylate esters are preferably derived from the aliphatic diols, preferably from C₂₋₁₀ aliphatic diols, preferably from C₂₋₆ aliphatic diols, preferably from C₂, C₃ or C₄ aliphatic diols, more preferably from ethylene glycol, 1,3-propanediol and 1,4-butanediol, more preferably from ethylene glycol.

A particularly suitable lithium salt has the formula (I) below, and is referred to herein as dilithium bis hydroxy ethyl terephthalate (DL-BHET):

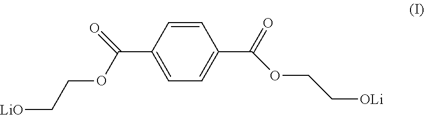

During use and operation of the lithium-ion wet cell battery, the lithium ions present in the electrolyte are mobile, enabling the required conductivity.

It has been found that, during use and operation of the lithium-ion wet cell battery, the lithium ions saturates the copolyester film. In other words, during use and operation of the lithium-ion wet cell battery, the copolyester film further comprises lithium ions.

The electrolyte preferably further comprises at least one organic solvent. Suitable organic solvents include one or more of esters, ethers, cyclic and acyclic carbonates such as ethylene carbonate, ethyl methyl carbonate, dimethyl carbonate, diethyl carbonate and propylene carbonate. Preferably the solvent comprises ethylene carbonate and ethyl methyl carbonate.

Preferably, the lithium salt is dissolved in the organic solvent. The concentration of lithium salt in the organic solvent is preferably from about 3M to about 0.1 M, preferably from about 2.5M to about 0.3M, preferably from about 2 to about 0.4M, preferably from about 1.5 to about 0.5M, preferably from about 1.4M to about 0.6M, preferably from about 1.3M to about 0.7M, preferably from about 1.2M to about 0.8M, preferably about 1M. For example, the concentration of the lithium salt (preferably LiPF₆) in the organic solvent (preferably ethylene carbonate:dimethyl carbonate) may be 1 M.

The electrolyte may further comprise any other additive conventionally employed in the manufacture of lithium-ion wet cell batteries. For example, the electrolyte may further comprise vinylene carbonate, fluoroethylene carbonate, difluoroethylene carbonate, pyridine-containing additives such as pyridine-boron trifluoride and pyridine phosphorus pentafluoride, methylene methanedisulfonate, methylene ethylene carbonate, propargyl methanesulfonate, tris(trimethylsilyl)phosphite. Such additives may be introduced into the electrolyte in a conventional manner. To provide acceptable electrochemical performance, additives are typically used in only small amounts, generally such that the total weight of additive is not more than about 5.0%, preferably not more than about 4.0%, preferably not more than about 3.0%, preferably not more than about 2.5%, preferably not more than about 2.0%, preferably about 1.0% by weight, based on the weight of the electrolyte.

Preferably the conductivity of the film in the wet cell battery is at least about 10⁻¹¹ S/m, preferably at least about 10⁻¹⁰ S/m, preferably at least about 10⁻⁹ S/m, preferably at least about 10⁻⁸ S/m, preferably at least about 10⁻⁷ S/m, preferably at least about 10⁻⁶ S/m, preferably at least about 10⁻⁵ S/m, preferably at least about 10⁻⁴ S/m, measured at 25° C., and preferably measured at 25° C. and 75° C.

Preferably, one or both of the anode and cathode may comprise a metallised polymeric film comprising a polymeric film substrate and a conductive metal layer, preferably wherein the polymeric film support is a polyester film.

The preferences and elements described in respect of the first aspect of the invention apply equally to the second aspect of the invention.

According to a third aspect of the present invention, there is provided a method of manufacturing a lithium-ion wet cell battery comprising an anode, a cathode, a separator between the anode and the cathode, and an electrolyte, the method comprising the steps of:
(a) preparing or obtaining a separator which is or comprises (and preferably consists of) a copolyester film as described herein;
(b) preparing or obtaining an electrolyte;
(c) assembling the battery, wherein the battery comprises an anode, a cathode, a separator between the anode and the cathode, and an electrolyte, wherein said separator is obtained from step (a) and wherein said electrolyte is obtained from step (b).

In the method of the third aspect, said copolyester film is contacted with said electrolyte either before or after said copolyester film is disposed in said battery as a separator between the anode and the cathode. Preferably, however, in the method of the third aspect, said copolyester film is contacted with said electrolyte prior to said copolyester film being disposed in said battery as a separator between the anode and the cathode. Said copolyester film may be contacted with said electrolyte by any suitable means, and is preferably so contacted by soaking said copolyester film in a container of said electrolyte.

The method of the third aspect corresponds to the method of the second aspect except that the copolyester film already comprises lithium ions (hereinafter referred to as “intrinsic lithium ions”) prior to contacting with said electrolyte. Said intrinsic lithium ions are introduced into the copolyester prior to film formation. The preferences and elements described in respect of the first and second aspects of the invention otherwise apply equally to the third aspect of the invention.

These intrinsic lithium ions may be introduced into the copolyester from which the copolyester film is derived either during synthesis of the copolyester, or during a separate compounding step in which the copolyester is compounded with a lithium salt. The lithium salt is preferably introduced during synthesis of the copolyester.

In a preferred embodiment, the lithium salt is added to the reactant(s) at the start of the synthetic procedure to make the copolyester. Preferably said synthetic procedure comprises the steps of:

(i) reacting an aliphatic diol with an aromatic dicarboxylic acid or an ester thereof (suitably a lower alkyl (C₁₋₄) ester, preferably the dimethyl ester), to form a bis(hydroxyalkyl)-ester of said aromatic dicarboxylic acid;

(ii) polymerising in a polycondensation reaction said bis(hydroxyalkyl)-ester of said aromatic dicarboxylic acid in the presence of the poly(alkylene oxide), suitably under conditions of elevated temperature in the presence of a catalyst; and

(iii) preferably subjecting the reaction product of step (ii) to solid state polymerisation.

In an alternative embodiment, the lithium salt is added to the reaction product of the direct esterification or trans-esterification step (i), and before the polymerisation stage, enabling the lithium salt to be present in the copolyester.

In a further embodiment, the lithium salt is added at the end of polymerisation, preferably after completion of step (ii) and prior to any solid state polymerisation, by mixing the lithium salt into the copolyester melt.

The lithium salt(s) which provide said intrinsic lithium ions is/are preferably selected from the same lithium salts already described hereinabove. The lithium salt(s) which provide said intrinsic lithium ions may be the same as or different to the lithium salt(s) present in the electrolyte prepared or obtained according to step (b) of the method of the third aspect, and in one embodiment they are the same.

In the method of the third aspect, the intrinsic lithium ions of the copolyester film of step (a) may be held within the polymeric matrix of the film by virtue of the interaction between the lithium cation and the polarisable electronegative oxygen atoms of the copolyester, preferably at least the electronegative oxygen atoms of the poly(alkylene oxide) units. Preferably, however, the lithium ions are held within the polymeric matrix of the film by virtue of the interaction between the lithium cations and the anion of a lithium salt. Thus, in this preferred embodiment, a lithium salt is held within the polymeric matrix and the lithium salt is not part of the polymer backbone.

The amount of intrinsic lithium ions present in the copolyester film is preferably effective to provide an Li:O, molar ratio of from about 5:1 to about 1:50, preferably from about 4:1 to about 1:50, preferably from about 3:1 to about 1:50, preferably from about 2:1 to about 1:50, preferably about 1:1 to about 1:40, preferably about 1:2 to about 1:30, preferably about 1:4 to about 1:25, wherein the number of 0 atoms in this ratio is defined as the number of O atoms in the poly(alkylene oxide) residue.

Preferably, the intrinsic lithium ions are present in amounts of no more than about 5.0 wt % by total weight of the copolyester film, preferably no more than about 3.5 wt %, preferably no more than about 2.0 wt %, preferably no more than about 1.5 wt %, and preferably at least about 0.01%, preferably at least about 0.05%, preferably at least about 0.10 wt %, preferably at least about 0.25 wt %, and preferably from about 0.01 wt % to about 5.0 wt %, preferably from about 0.05 wt % to about 3.5 wt %, preferably from about 0.10 wt % to about 2.0 wt %, preferably from about 0.25 wt % to about 1.5 wt %.

The following test methods were used to characterise the properties of the novel products disclosed herein.

(i) Glass Transition Temperature (T_{g}), Crystalline Temperature (Tₐ) and Crystalline Melting Point (Tₘ)
These thermal parameters were measured by differential scanning calorimetry (DSC) using a Perkin Elmer HyperDSC 8500. Unless otherwise stated, measurements were made according to the following standard test method and based on the method described in ASTM E1356-98. The sample was maintained under an atmosphere of dry nitrogen for the duration of the scan. A flow rate of 20 ml min⁻¹ and Al pans were used. Samples (5 mg) were initially heated at 20° C. min⁻¹ from 20° C. to 350° C. in order to erase the previous thermal history (1st heating scan). After an isothermal hold at 350° C. for 2 min, samples were cooled at 20° C. min⁻¹ to 20° C. (1st cooling scan). Samples were then reheated at 20° C. min⁻¹ to 350° C. (2^{nd} heating scan). Values of T_{g} and TM were obtained from 2^{nd} heating scans. As is well known, the glass transition temperature of a polymer is the temperature at which it changes from a glassy, brittle state to a plastic, rubbery state.
   The value of a T_{g} was determined as the extrapolated onset temperature of the glass transition observed on the DSC scans (heat flow (W/g) against temperature (° C.)), as described in ASTM E1356-98. It will be appreciated that the copolyesters of the present invention may be associated with two T_{g} values, one T_{g} for the soft segments and one T_{g} for the hard segments.
   The values of T_{c} and T_{g} were determined from the DSC scans as the peak exotherm or endotherm of the transition.

(ii) Melt Viscosity
The term “melt viscosity” as used herein means the complex viscosity of a polymer measured at a particular melt temperature and a particular frequency of oscillation. The complex viscosity was measured by rotational rheology testing using a TA Instruments DHR-1 according to the following test method. Polymer samples (2.5 g) were dried under dynamic vacuum at 140° C. for 16 h. The samples were then held between 2×25 mm diameter parallel plates and heated to the required temperature under a nitrogen atmosphere. Analysis of the complex viscosity of the polymer was performed via a temperature ramp method, whereby samples were heated at a rate of 4° C. min⁻¹, at constant strain (5%) and angular frequency (10 rad s⁻¹).
(iii) Through-Film Ionic Conductivity (Dry Cell Setup (Solid State))

The through-film ionic conductivity of film samples with no additional electrolyte present, i.e. in the dry cell setup (solid state), was determined by Electrochemical Impedance Spectroscopy (EIS). Symmetric lithium/lithium dry coin cells with 1×1 mm spacers were constructed at a dew point of <40° C. in an argon glove box. Prior to assembly, polymer film samples with a thickness of 10 μm were sputtered with about 7 nm of Au/Pd on each side of the film using a Cressington 208HR High Resolution Sputterer. The film samples were then placed between lithium metal discs that were cleaned with blade and Scotch-Brite™ before use. AC impedance spectra were obtained using a Bio-Logic BCS unit in the frequency range 10 kHz to 100 mHz at about 25° C. following a perturbation voltage of 20 mV. The bulk resistance R_{b} was calculated from the x-axis intercept on the Nyquist impedance plot generated.
The through-film ionic conductivity δ was calculated from R_{b} using the formula:

$$δ = \frac{1}{{R}_{b}} \frac{d}{s}$$

where d is the film sample thickness and s is the area of electrodes contacting with the SPE film. The conductivity is expressed in Siemens/m, usually in the form of its logarithm (base 10).

(iv) Through-Film Ionic Conductivity (Wet Cell Setup (Electrolyte Present))
The through-film ionic conductivity of film samples with electrolyte present i.e. in the wet cell setup, was assessed by Electrochemical Impedance Spectroscopy (EIS). Symmetric lithium/lithium coin cells were constructed at a dew point of <40° C. in an argon glove box. Prior to coin cell construction, the film sample was soaked in electrolyte. The electrolyte used was 1M LiPF₆ in ethylene carbonate:ethyl methyl carbonate (EC:EMC) with 1 wt % vinylene carbonate (VC). The film sample was then placed between a graphite anode and a NMC (Nickel Manganese Cobalt 622) cathode. The total cell capacity was calculated to be 1.6 mAh/g. AC impedance spectra were obtained using a Bio-Logic BCS unit in the frequency range 100 kHz to 100 mHz at an operating temperature of the battery (within the range of about 25° C. and about 75° C.) following a perturbation voltage of 5 mV and conditioning cycle time of 9×10⁴ s. The bulk resistance R_{b} was calculated from the x-axis intercept on the Nyquist impedance plot generated. The through-film ionic conductivity δ was calculated from R_{b} using the formula:

$$δ = \frac{1}{{R}_{b}} \frac{d}{s}$$

where d is the film sample thickness and s is the area of electrodes contacting with the SPE film. The conductivity is expressed in Siemens/m, usually in the form of its logarithm (base 10).

(v) Molecular Weight (M_{w})
GPC measurements were performed on a Malvern/Viscotek TDA 301 using an Agilent PL HFIPgel guard column plus 2×30 cm PL HFIPgel columns. A solution of HFIP with 25 mM NaTFAc was used as eluent, with a nominal flow rate of 0.8 mL min⁻¹. All experimental runs were conducted at 40° C., employing a refractive index detector. Molecular weights are referenced to polymethylmethacrylate calibrants. Data capture and subsequent data analysis were carried out using Omnisec software. Samples were prepared at a concentration of 2 mg mL⁻¹, with 20 mg of sample dissolved in 10 mL eluent. These solutions were stirred for 24 h at room temperature and then warmed at 40° C. for 30 mins to fully dissolve the polymer. Each sample was filtered through a 0.45 μm polytetrafluoroethylene membrane prior to injection.
   Determination of Mₙ is made using the GPC measurement described herein.
   Once the M_{w} and Mₙ values are known, the PDI is determined.

(vi) Thermal Stability

The thermal stability of the copolymers was assessed by thermogravimetric analysis. The samples were analysed on a Mettler Toledo TGA1 in Al₂O₃ pans (40 μL capacity) under a nitrogen purge. Polymer samples (5 mg) were equilibrated at 20° C. before being heated to 600° C. at 10° C. min⁻¹. The thermal stability is assessed by measuring the thermal degradation temperature, T_{d}, which is defined as the temperature at which 10% mass loss has occurred.

(vii) Thermal Shrinkage
Shrinkage was assessed for film samples (preferably having dimensions 200 mm×10 mm) which were cut in specific directions relative to the machine and transverse directions of the film and marked for visual measurement. The longer dimension of the sample (i.e. the 200 mm dimension) corresponds to the film direction for which shrinkage is being tested, i.e. for the assessment of shrinkage in the machine direction, the longer dimension of the test sample is oriented along the machine direction of the film. After heating the specimen to the predetermined temperature (by placing in a heated oven at that temperature) and holding for the predetermined interval, it was cooled to room temperature and its dimensions re-measured manually. The thermal shrinkage was calculated and expressed as a percentage of the original length.

(viii) Extractables Content
The Soxhlet extraction method is commonly identified as a continuous extraction technique, whereby the partially soluble components of a solid are transferred to a liquid solvent by means of a Soxhlet extractor. In the present invention, this method is utilised for the quantification of residual low molecular weight material, oligomers and/or unreacted comonomers which may be present after synthesis of the copolyesters. Polymer samples (15 g) were dried under vacuum at 65-70° C. for 16 h, prior to reflux for 6 h in xylene (200 mL) within Quickfit Soxhlet extraction apparatus consisting of: 250 mL round bottom flask; Whatman cellulose extraction thimble; double surface Davies condensers; and Soxhlet extractor jacketed body. Excess xylene was removed under vacuum at reduced pressure, to afford the extracted material. The total extractables content is expressed as an average of 2 measurements in percentage form, via the ratio of extracted material against starting polymer mass:

$$Extractables ( \% ) = ( \frac{Extracted mass}{Sample mass} ) * 100$$

The composition of the extractables content, and particularly the amount of unreacted poly(alkylene oxide) can then be determined by conventional analytical techniques, and preferably by ¹H NMR spectroscopy.

(ix) Level of Poly(Alkylene Oxide) in the Copolyester
1H NMR spectroscopy was used to determine the level of poly(alkylene oxide) in the copolyester, using an ECS400 spectrometer at 80° C., referenced to residual solvent (d₂-TCE (1,1,2,2-tetrachloroethane)) resonances.

The invention is further illustrated by the following examples. It will be appreciated that the examples are for illustrative purposes only and are not intended to limit the invention as described above. Modification of detail may be made without departing from the scope of the invention.

### EXPERIMENTAL

### Experiment 1

A series of copolyesters was made using terephthalic acid, ethylene glycol and polyethylene glycol (PEG3450). PEG3450 was present at a level of 10 to 12 wt % of the copolyester. The copolyesters were made by reacting 2050 kg terephthalic acid, 1050 kg ethylene glycol and 700 kg PEG3450 under pressure (about 40 psi) at high temperature (about 240° C.), along with the addition of an antioxidant (Irganox® 1010, 1300 g) and china clay (5.2 kg). A trace of sodium hydroxide (130 g) was added to prevent the formation of unwanted by-products, and the esterification reaction proceeded without the need of a catalyst. Water was distilled off from the reaction and the reaction stopped once 90% of the theoretical weight of water from the reaction had been collected. Phosphoric acid stabiliser (975 g) was added to neutralise the base. Polycondensation was then effected with an antimony trioxide catalyst (1040 g) at about 280° C., and wherein the pressure above the melt was reduced to less than 1 mm Hg. As the polycondensation reaction proceeded, the viscosity of the batch increased, and once a pre-determined viscosity had been achieved the polymerisation reaction was stopped by restoring the pressure in the vessel back to atmosphere. The copolyester was then extruded as a lace and cast into a water bath, dried and pelletized before being subjected to solid state polymerisation under dynamic vacuum at about 210° C. for about 24 hours.

These copolyesters were then extruded through a film-forming die on to a water-cooled rotating, quenching drum at various line speeds to yield an amorphous cast composite extrudate. The cast extrudate was heated to a temperature of between about 50 and 60° C. and then stretched longitudinally at a forward draw ratio of about 3.3. The polymeric film was pre-heated to 65 to 70° C. and passed into a stenter oven at a temperature of from 75 to 85° C. where the sheet was stretched in the sideways direction to approximately 4 times its original dimensions. The film was then heat-set under dimensional restraint in a 3-stage crystalliser held at temperatures within the range of 180° C. to 220° C. with dimensional relaxation of up to 5% in the transverse dimension. The final thickness of the film was 10 μm.

The through-film ionic conductivity of the film was measured in both the dry cell setup (solid state), and the wet cell set-up (electrolyte present) and the results are shown in Table 1 below.

TABLE 1

| | | Through-film Ionic |
|---|---|---|
| | Operating Temperature | Conductivity |
| Setup | (° C.) | (S m⁻¹) |
| Dry cell | 25 | 5.0 × 10⁻⁸ |
| Wet cell | 25 | 2.8 × 10⁻⁷ |
| Wet cell | 30 | 3.4 × 10⁻⁶ |
| Wet cell | 40 | 1.6 × 10⁻⁵ |
| Wet cell | 50 | 8.1 × 10⁻⁵ |
| Wet cell | 60 | 2.3 × 10⁻⁴ |
| Wet cell | 70 | 5.1 × 10⁻⁴ |
| Wet cell | 75 | 6.0 × 10⁻⁴ |

These results demonstrate that the copolyester films described herein have excellent through-film ionic conductivity at a low thickness of 10 μm. In particular, the copolyester films of the present invention have excellent through-film ionic conductivity when used as a separator in a wet cell battery with a lithium-based electrolyte across a range of commercially important operating temperatures.

### Experiment 2

A lithium-ion wet cell battery was prepared. The film of experiment 1 was soaked in the electrolyte. A composition comprising 1M LiPF₆ in ethylene carbonate:ethyl methyl carbonate (EC:EMC) with 1 wt % vinylene carbonate (VC) was used as the electrolyte. The soaked film was then placed between a graphite anode and a NMC (Nickel Manganese Cobalt 622) cathode to prepare the lithium-ion wet cell battery.

1. Use of a copolyester film in the manufacture of a lithium-ion wet cell battery comprising an anode, a cathode and an electrolyte, wherein the copolyester film comprises a copolyester which comprises repeating units derived from a diol, a dicarboxylic acid and a poly(alkylene oxide)glycol, wherein said copolyester film does not comprise lithium ions, wherein said copolyester film is an oriented film, and wherein during said manufacture said copolyester film is disposed in said battery as a separator between the anode and the cathode.

2. A use according to claim 1 wherein during said manufacture, said copolyester film which does not comprise lithium ions is contacted with said electrolyte prior to said copolyester film being disposed in said battery as a separator between the anode and the cathode.

3. A use according to claim 1 or 2 wherein said film has a thickness of no more than about 25 μm, preferably no more than about 20 μm, preferably no more than about 18 μm, preferably no more than 15 μm.

4. A use according to any preceding claim, wherein said film has a thickness of from about 0.3 μm, preferably from about 0.5 μm, preferably from about 0.9 μm, preferably from about 1.0 μm.

5. A use according to any preceding claim, wherein said copolyester comprises semi-crystalline segments derived from said diol and said dicarboxylic acid, and amorphous segments derived from said poly(alkylene oxide) glycol.

6. A use according to any preceding claim wherein the glycol is an aliphatic glycol, preferably wherein the glycol is selected from C₂, C₃ or C₄ aliphatic diols, preferably wherein the glycol is ethylene glycol.

7. A use according to any preceding claim wherein the dicarboxylic acid is an aromatic dicarboxylic acid, preferably wherein the dicarboxylic acid is selected from naphthalene dicarboxylic acid and terephthalic acid, preferably wherein the dicarboxylic acid is terephthalic acid.

8. A use according to any preceding claim wherein the poly(alkylene oxide) glycol is selected from polyethylene glycol (PEG) and/or polypropylene glycol (PPG), preferably wherein the poly(alkylene oxide) is polyethylene glycol (PEG).

9. A use according to any preceding claim wherein the weight average molecular weight of the poly(alkylene oxide) glycol is from about 200 to about 20000 g/mol, preferably from about 400 to about 3900 g/mol, preferably from about 500 to about 3900 g/mol, preferably from about 500 to about 3800 g/mol, preferably from about 500 to about 3700 g/mol, preferably about 3450 g/mol.

10. A use according to any preceding claim wherein the film further comprises an antioxidant.

11. A use according to any preceding claim wherein the film exhibits a conductivity of at least about 10⁻⁸ S/m, preferably at least about 10⁻⁷ S/m, preferably at least about 10⁻⁶ S/m, preferably at least about 10⁻⁵ S/m, preferably at least about 10⁻⁴ S/m, measured at 25° C.

12. A use according to any preceding claim wherein the film exhibits a shrinkage of less than 5.0% after 30 mins at 100° C. in both dimensions of the film.

13. A use according to any preceding claim wherein the film is a biaxially oriented film.

14. A use according to any preceding claim wherein the film is a self-supporting film.

15. A use according to any preceding claim wherein the film has a crystalline melting point (Tₘ) of greater than 175° C.

16. A use according to any preceding claim wherein the film has a glass transition point (T_{g}) of no more than 60° C.

17. A method of manufacturing a lithium-ion wet cell battery comprising an anode, a cathode, a separator between the anode and the cathode and an electrolyte, the method comprising the steps of:
(a) preparing or obtaining a separator which is or comprises a copolyester film which does not comprise lithium ions as defined in any of claims 1 to 16;
(b) preparing or obtaining an electrolyte;
(c) assembling the battery, wherein the battery comprises an anode, a cathode, a separator between the anode and the cathode, and an electrolyte, wherein said separator is obtained from step (a) and wherein said electrolyte is obtained from step (b).

18. A method according to claim 17 wherein said copolyester film which does not comprise lithium ions is contacted with said electrolyte prior to said copolyester film being disposed in said battery as a separator between the anode and the cathode.

19. A method of manufacturing a lithium-ion wet cell battery comprising an anode, a cathode, a separator between the anode and the cathode, and an electrolyte, the method comprising the steps of:
(a) preparing or obtaining a separator which is or comprises an oriented copolyester film wherein the oriented copolyester film comprises a copolyester which comprises repeating units derived from a diol, a dicarboxylic acid and a poly(alkylene oxide)glycol;
(b) preparing or obtaining an electrolyte;
(c) assembling the battery, wherein the battery comprises an anode, a cathode, a separator between the anode and the cathode, and an electrolyte, wherein said separator is obtained from step (a) and wherein said electrolyte is obtained from step (b),
and wherein the copolyester film already comprises lithium ions prior to contacting with said electrolyte, wherein said lithium ions are intrinsic lithium ions introduced into the copolyester from which the copolyester film is derived prior to film formation.

20. A method according to claim 19 wherein said copolyester film is as defined in any of claims 3 to 16.

21. A method according to claim 17, 19 or 20 wherein said copolyester film is contacted with said electrolyte either before or after said copolyester film is disposed in said battery as a separator between the anode and the cathode.

22. A method according to claim 19 or 20, or according to claim 21 when dependent from claim 19 or 20, wherein said intrinsic lithium ions are introduced into the copolyester from which the copolyester film is derived prior to film formation during synthesis of said copolyester or during a separate compounding step in which said copolyester is compounded with a lithium salt.

23. A use according to any one of claims 1 to 16, or a method of manufacturing according to any of claims 17 to 22, wherein the electrolyte comprises lithium hexafluorophosphate (LiPF₆), lithium hexafluoroarsenate (LiAsF₆), lithium tetrafluoroborate (LIBF₄), lithium bis(trifluoromethanesulfonyl)imide (LiTFSI), lithium thiocyanate (LiSCN), lithium trifluoromethanesulfonate (LiCF₃SO₃), lithium bromide (LiBr), lithium iodide (LiI), lithium bis(trifluoromethanesulfonimide), (LiN(CF₃SO₂)₂), lithium tris(trifluoromethylsulfonyl)methide (LiC(CF₃SO₂)₃), lithium orthosilicate (Li₄O₄Si), lithium trifluoroacetate (LiCF₃CO₂), lithium bis(fluorosulfite)amide (LiN(FO₂S)₂)LiClO₄, lithium iron phosphate (LiFePO₄), lithium bis(oxalate)borate (LiBOB) and/or lithium difluorophosphate (LiPO₂F₂).

24. A use according to any one of claim 1 to 16 or 23, or a method according to any of claims 17 to 23, wherein the electrolyte comprises ethylene carbonate and ethyl methyl carbonate.
